(19) United States
(12) Patent Application Publication
(10) Pub. No.: US 2012/0266220 A1
(43) Pub. Date: Oct. 18, 2012

(54) System and Method for Controlling Access to a Third-Party Application with Passwords Stored in a Secure Element

(75) Inventors: David Brudnicki, Duvall, WA (US); Hans Reisgies, San Jose, CA (US)

(73) Assignee: Sequent Software Inc., Redwood City, CA (US)

(21) Appl. No.: 13/447,489

(22) Filed: Apr. 16, 2012

Related U.S. Application Data
(63) Continuation-in-part of application No. 13/279,184, filed on Oct. 21, 2011.
Application No. 13/279,184 is a continuation-in-part of application No. 13/279,147, filed on Oct. 21, 2011.
(60) Provisional application No. 61/414,847, filed on Nov. 17, 2010.
(60) Provisional application No. 61/414,845, filed on Nov. 17, 2010.

(51) Int. Cl. G06F 21/00

(52) U.S. Cl. 726/6

(57) ABSTRACT

A system for controlling access to an application on a portable communication device having a secured element and a user interface comprises memory associated with the secure element; a card management module operably associated with the portable communication device and with the secure element capable of controlling the secured element to facilitate writing to and reading from the memory; and a password management module operably associated with the card management module, the portable communication device user interface, and the application, the password management module receiving an application identifier associated with the application, a user name, and a password from the user interface, and providing an access command to the application based on whether the received user name and password match information stored in the memory.

This application claims priority to U.S. patent application Ser. No. 13/279,184, filed on Oct. 21, 2011, entitled “System and Method for Providing Secure Data Communication Functionality to a Variety of Applications on a Portable Communication Device,” which claims priority to U.S. Provisional Patent Application No. 61/414,847, filed on Nov. 17, 2010, entitled “System and Method for Providing Secure Data Communication Functionality to a Variety of Applications on a Portable Communication Device.” This application also claims priority from U.S. patent application Ser. No. 13/279,147, filed on Oct. 21, 2011, entitled “System and Method for Providing a Virtual Secure Element on a Portable Communication Device,” which claims priority to U.S. Provisional Patent Application No. 61/414,845, filed on Nov. 17, 2010, entitled “System and Method for Providing a Virtual Secure Element on a Portable Communication Device.”

### TECHNICAL FIELD

The present invention relates generally to the use of a secure element on a portable device, and more particularly to a controlling access to one or more third-party applications via passwords stored in the secure element.

### BACKGROUND

Many applications have been developed for use in association with portable communications devices. Some of these applications would benefit from robust security protocols—for example, a password manager application for storing passwords and PIN codes (generically referred to as “passwords”), or a mobile database application that stores personally identifiable information or other confidential information. In the case of a password manager, such password managers are well known to allow users to manage one or more passwords in a single location or database (referred to as a “password key ring”). Current applications provide some security, but are vulnerable to hacking or leakage of data or information. In fact, many current applications have the password functionality stored in regular memory as depicted in FIG. 1 and are, as above, vulnerable to even unsophisticated hacking or leakage of data and information.

Accordingly, there is a need in the industry for a more secure means to verify passwords used by third party programs. Many portable communications devices now have secure elements to provide a higher level of security to support electronic financial transactions. Usually access to these secure elements is limited to such financial applications because secure elements are designed to self-destruct if someone improperly accesses the data stored within or physically tampers with the card. Thus, by limiting the types of programs that access these secure elements, inadvertent destruction has been avoided. However, in view of the increase need for security (particularly in portable devices) there is a need for an intermediary to provide safe password storage and verification for third-party applications via a secure element to minimize the occurrence of inadvertent self-destruction of secure elements.

Accordingly, the present invention seeks to provide one or more solutions to the foregoing problems and related problems as would be understood by those of ordinary skill in the art having the present specification before them. These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### SUMMARY OF THE INVENTION

In one embodiment, the system for controlling access to an application on a portable communication device having a secured element and a user interface comprises memory associated with the secure element; a card management module operably associated with the portable communication device and with the secure element capable of controlling the secured element to facilitate writing to and reading from the memory; and a password management module operably associated with the card management module, the portable communication device user interface, and the application, the password management module receiving an application identifier associated with the application, a user name, and a password from the user interface, and providing an access command to the application based on whether the received user name and password match information stored in the memory.

In one embodiment, the memory associated with the secure element may be within the secure element. In another embodiment, the memory associated with the secure element is outside the secure element and an encryption key is used to encrypt contents of the memory. The encryption key may be stored within the secured element. The secure element includes a pseudo-random number generator, the graphical user interface further comprising an interface for creating passwords with portions generated by the pseudo-random number generator. The memory may be located within the portable communication device. In one embodiment, the operable connection between the card management module and the graphical user interface is a trusted connection.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless otherwise specified.

FIG. 1 illustrates the current prior art approach to controlling access to an application, wherein a password is stored in unsecured memory (i.e. not the secure memory) and the application verifies whether the password input by a user matches the unsecured memory toward granting access to the application.

FIG. 2 is an illustration of a screen from an exemplary third-party application that may be deployed on a smart phone.

FIG. 3 is a block diagram illustrating one potential implementation of the system for controlling access to a third-party application with passwords stored in a secure element.

FIG. 4 is a block diagram illustrating in one potential implementation of the system illustrating how the secure memory may be accessed to securely read, write and store passwords for the third-party applications.

FIG. 5 is a block diagram of one potential implementation of a system underlying the password verification system used by third-party apps 200c to view, select and/or change secure password information stored in the secure element.

FIG. 6 is a block diagram illustrating one embodiment of the invention within a portable communication device that may be relevant to the present system.

FIG. 7 illustrates potential operable interconnections between an end user's smartphone and various subsystems, including the system management back end.

FIG. 8 is an illustration of a screen from which a strong password may be generated on a smart phone.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention and its components may take the form of an entirely hardware embodiment, an entirely software embodiment or an embodiment combining software and hardware aspects. The following detailed description is, therefore, not to be taken in a limiting sense.

### Portable Communication Devices

The present invention provides a system and method that can be utilized with a variety of different portable communication devices 50, including but not limited to PDA's, cellular phones, smart phones, laptops, tablet computers, and other mobile devices that include cellular voice and data service as well as preferable access to consumer downloadable applications. One such portable communication device could be an iPhone, Motorola RAZR or DROID; however, the present invention is preferably platform and device independent. For example, the portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device.

The portable communication device would likely include one or more short proximity electromagnetic communication devices, such as an NFC, RFID, or Bluetooth transceiver. It is presently preferred to use an NFC baseband that is Compliant with NFC IP 1 standards (www.nfcforum.org), which provides standard functions like peer-to-peer data exchange, reader-writer mode (i.e., harvesting of information from RFID tags), and contactless card emulation (per the NFC IP 1 and ISO 14443 standards) when paired with a secure element on the portable communication device and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an NFC/RFID antenna (conformed to NFC IP 1 and ISO 14443 standards) to enable near field communications. However, as would be understood in the art NFC/RFID communications may be accomplished albeit over even shorter ranges and potential read problems.

The portable communication device also preferably includes a mobile network interface to establish and manage wireless communications with a mobile network operator. The mobile network interface uses one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (NIC). It is contemplated that the mobile network interface and short proximity electromagnetic communication device could share a transceiver or transceiving device, as would be understood in the art by those having the present specification, figures, and claims before them.

The portable communication device further includes a user interface that provides some means for the consumer to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. As would be understood in the art by those having the present specification, figures, and claims before them, the portable communication device may further include a location transceiver that can determine the physical coordinates of the device on the surface of the Earth typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (AGPS), E-OTD, CI, SAI, ETA, BSS or the like, to determine the physical location of the portable communication device on the surface of the Earth.

The portable communication device will also include a microprocessor and mass memory. The mass memory may include ROM, RAM as well as one or more removable memory cards. The mass memory provides storage for computer readable instructions and other data, including a basic input/output system (“BIOS”) and an operating system for controlling the operation of the portable communication device. The portable communication device will also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

In the present invention each portable communication device may be thought to have two subsystems: (1) a “wireless subsystem” that enables communication and other data applications as has become commonplace with users of cellular telephones today, and (2) the “secure transactional subsystem” which may also be known as the “payment subsystem”. It is contemplated that this secure transactional subsystem will preferably include a secure element, as further described below. In one embodiment of the present invention, the portable device may not need or even have a wireless subsystem. The present invention is directed to securely storing a digital password key ring in the secure element, so there may be no need for the ability to communicate with a network, only the need to communication with an end user who may input passwords, keys, secrets, and other certifying credentials and, in turn, manually retrieve those passwords, keys, secrets, and other certifying credentials. With a network connection, however, applications may prove to have trusted status, which would be highly desirable.

### Mobile Network Operator

Each of the portable communications devices may be connected to at least one mobile network operator. The mobile network operator generally provides physical infrastructure that supports the wireless communication services, data applications and the secure transactional subsystem via a plurality of cell towers that communicate with a plurality of portable communication devices within each cell tower's associated cell. In turn, the cell towers may be in operable communication with the logical network of the mobile network operator, POTS, and the Internet to convey the communications and data within the mobile network operator's own logical network as well as to external networks including those of other mobile network operators. The mobile network operators generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the portable communication devices.

### Secure Transactional Subsystem

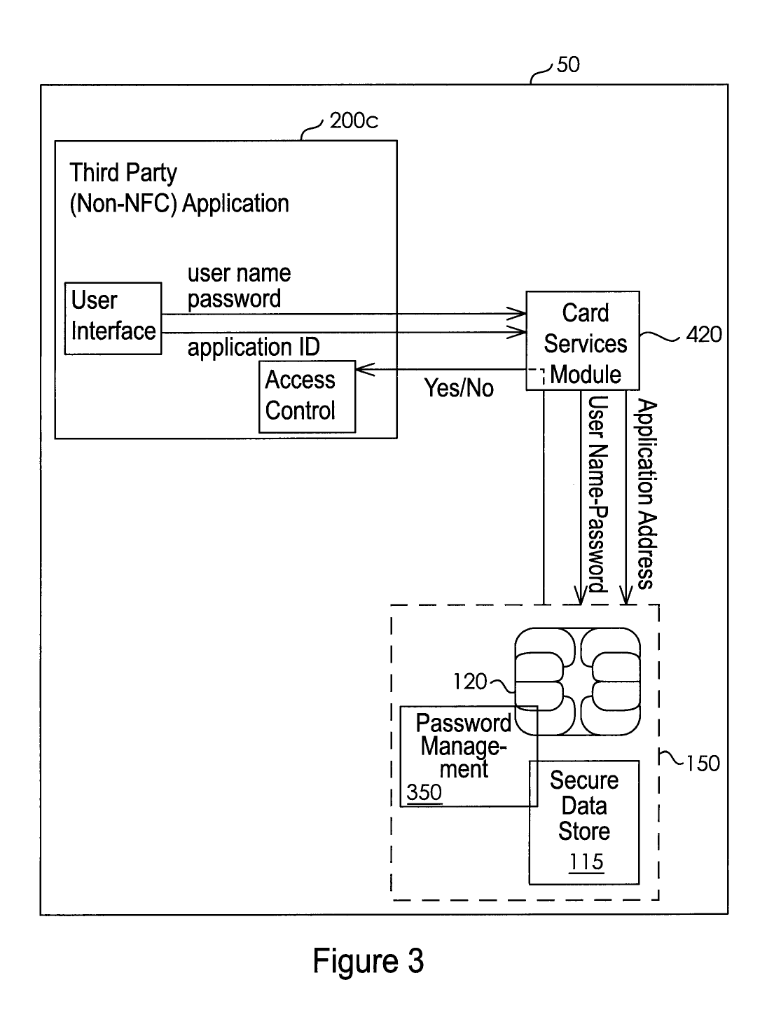

As shown in FIG. 3, the portable communications 50 includes a secure transactional subsystem 150. As depicted, the secure transactional subsystem may include a secure element 120, a secure data store 115, and associated device software for communication to management and provisioning systems as well as the customer facing interface for use and management of secure data stored in the secure element. “Secure elements” have most commonly been implemented as specialized, separate physical memories used for industry common practice of storing secure credentials such as: payment card track data used with industry common point of sales, employment badge credentials (enterprise access controls), hotel and other card-based access systems, and transit credentials. As further described below, the secure element may also be used to store other types of credentials accessible to a user and/or by one or more other applications on the portable communication device, such as a password manager application.

In one embodiment, the secure element is a separate physical memory chip, such as one similar (if not identical) to that described as part of the Global Platform 2.1.X, 2.2, or 2.2.X (www.globalplatform.org). Alternatively, or in addition, a “virtual” secure element (also referred to as a secure data store 115) may be implemented, such as that disclosed in co-pending U.S. patent application Ser. No. 13/279,147, which is fully incorporated into this application by reference. Preferably the secure transactional subsystem will conform, where appropriate, to an international standard, such as the standard defined in Global Platform 2.1.X or 2.2.

The invention relates to a system for more securely storing and verifying one or more passwords on a portable communication device. The system comprises a secure subsystem operably associated with the portable communication device, wherein the secure subsystem includes a secure element. The system may further include a card services module operably associated with the portable communication device and with the secure subsystem, wherein each of the one or more passwords is stored in the secure subsystem. The secure subsystem can further include a rewritable, encrypted memory having an encryption key stored in the secure element and an encryption engine operably connected to the rewritable, encrypted memory, the engine being capable of encrypting and decrypting data using the encryption key. FIG. 3 shows the relationship between the third party applications 200c, the card services module 420, and the secure transactional subsystem 150. (FIG. 3 refers to third party application 200c as being a “Non-NFC” application merely to highlight that even though the invention utilizes a secure element (commonly used in conjunction with NFC payment technology) the third party application need not be associated with NFC to take advantage of the present invention. However, the converse should be understood that third party NFC applications may be used with the present invention, as well. The secure subsystem includes the secure element 120 and the secure data store 115. Generally speaking the system can be used with any application or resource that could benefit from the greater security that is provided by storing and verifying passwords in association with the secure element 120.

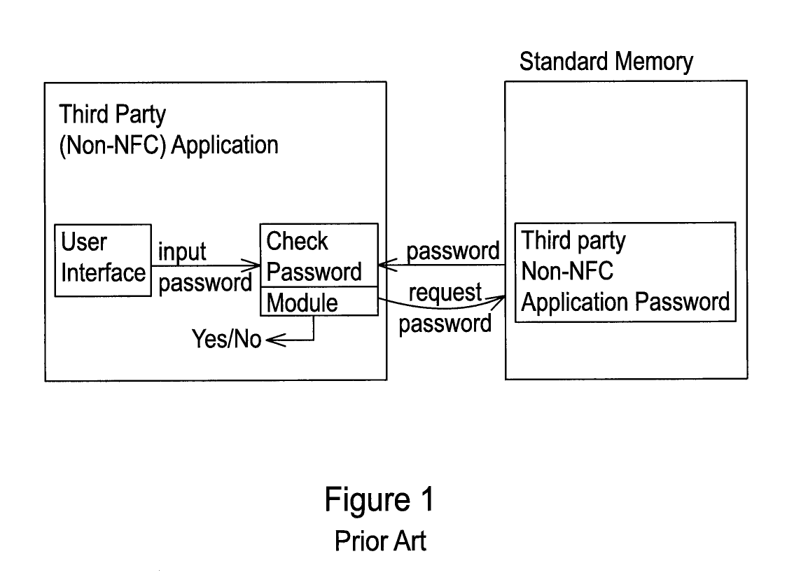

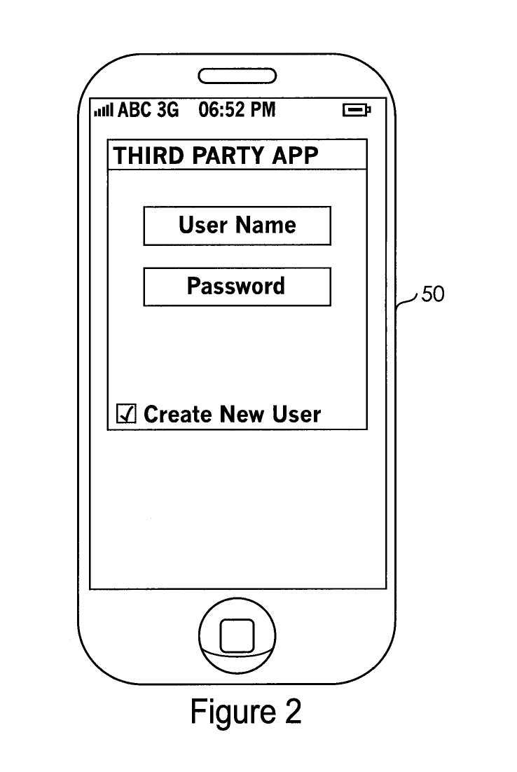

As illustrated in FIG. 2, when a third party application 200c requests a password, the user would input their user name and password just as they would have done in association with prior art systems. However, unlike the prior art approach (depicted in FIG. 1), as illustrated in FIG. 3 the user name and password information is passed from the third party application 200c, along with the relevant data to the card services module 420. The card services module 420 then routes the user name, password, and application ID to the secure element 120 within the secure transactional subsystem 150. All of the passwords are stored within the secure element and are provided with additional security because the passwords remain within the secure transactional subsystem 150 once they are saved within that system. When a user logs into the third party application 200c, upon inputting the password into the user interface (see FIG. 2), input by the user is routed to the secure element and is compared to the list of passwords stored in the secure element. The stored passwords preferably remain within the secure subsystem if not the stored element, itself, even during the comparison. If the input password matches the password stored in the secure element that is associated with third-party application 200c, the user will notice that access has been granted to the third party application 200c. If the passwords do not match, on the other hand, the requested access will be denied. Due to the nature of a secure element, outside the secure subsystem there will only be a yes/no indication after the password comparison.

### System Management Back End

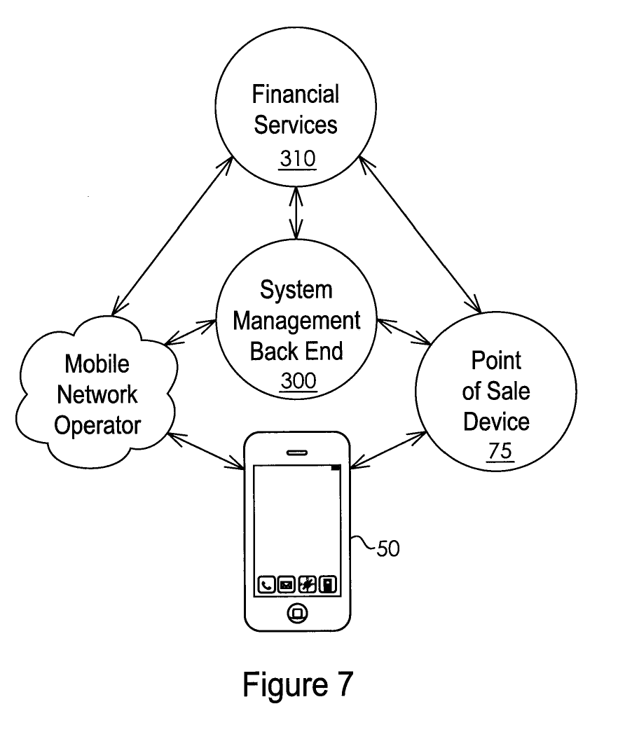

The system may be associated with a system management back end. As shown in FIG. 7, the system management back end 300 may be connected to the secure transactional subsystem located within a plurality of portable communication devices 50 via the infrastructure of at least one mobile network operator. The system management back end 300 likely has a server operably communicating with these one or more devices. The server may also be in operable communication with the retailer subsystem (i.e. point of sale devices 75) and financial services networks 310. The communications may include a variety of data and voice channels.

The system management back end server may comprise one or more general-purpose computers that implement the procedures and functions needed to run the system back office in serial or in parallel on the same computer or across a local or wide area network distributed on a plurality of computers and may even be located “in the cloud” (preferably subject to the provision of sufficient security). The computer(s) comprising the server may be controlled by Linux, Windows®, Windows CE, Unix, or a Java® based operating system, to name a few. The system management back end server is operably associated with mass memory that stores program code and data. Data may include one or more databases, text, spreadsheet, folder, file, or the like, that may be configured to maintain and store a knowledge base, user identifiers (ESN, IMSI, PIN, telephone number, email/IM address, billing information, or the like).

The system management back end server be operably coupled to a plurality of client computers. Each client computer associated with the system management back end server has a network interface device, graphical user interface, and voice communication capabilities that match the voice channel(s) supported by the client care center server, such as VoIP. Each client computer can request status of both the cellular and secure transactional subsystems of a portable communication device. This status may include the contents of the soft memory and core performance of portable communication device, the NFC components: baseband, NFC antenna, secure element status and identification. In this regard, the client computers may be used for customer care.

### Trusted Access Subsystem

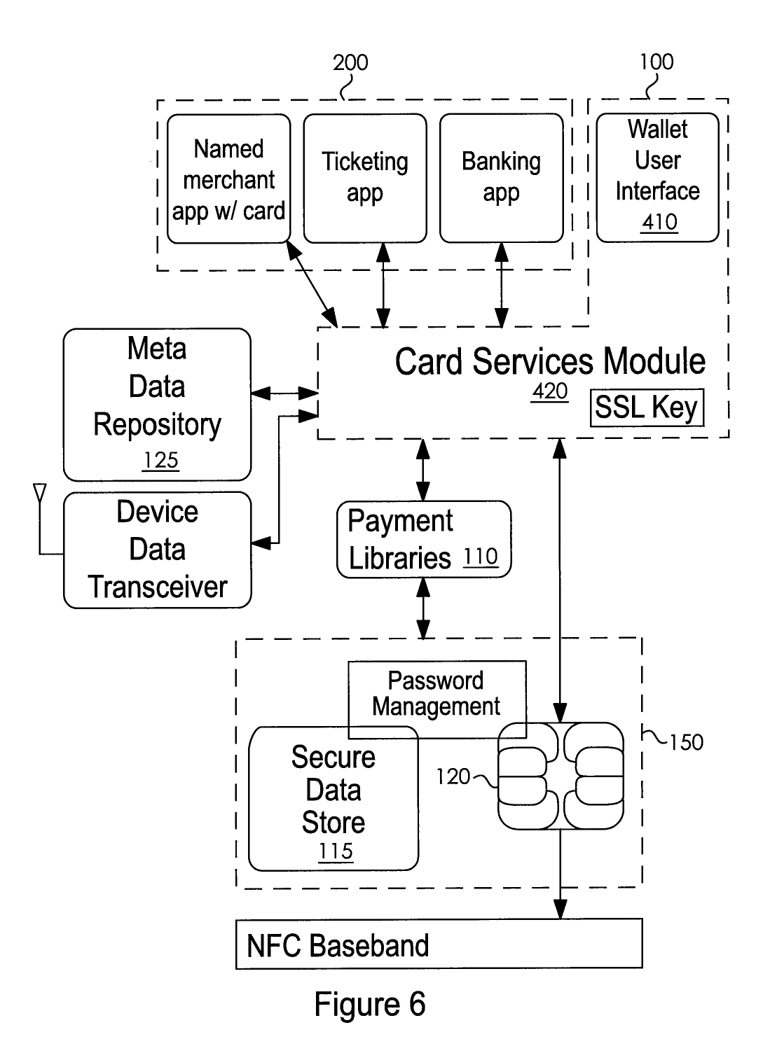

As shown in FIG. 6, each portable communication device 50 may contain one or more third-party applications 200, payment libraries 110, NFC Baseband, diagnostic agent 170, and a secure transactional subsystem 150 (which may include a secure data store 115 and/or a secure element 120, and/or a similar means). The secure data store 115, which may act as a “virtual” secure element, provides secured storage on the portable communication device 50. Various levels of security may be provided depending upon the nature of the data intended for storage in secure data store 115. For instance, secure data store 115 may simply be password-protected at the operating system level of device 50. As is known in these operating systems, the password may be a simple alphanumeric or hexadecimal code that is stored somewhere on the device 50. Alternatively, the data in secure data store 115 is preferably encrypted. Preferably, however, the secure data store 115 is set up as a virtual secure element in the manner disclosed in the co-pending patent U.S. patent application Ser. No. 13/279,147 (owned by the assignee of the present application) entitled “System and Method for Providing A Virtual Secure Element on a Portable Communication Device”, which is hereby incorporated in its entirety by reference. In addition to the passwords that may be stored in the secure transactional subsystem 150, credentials such as payment cards, coupons, access control and ticket data (e.g. transportation, concert) may also be stored. Some of these payment types may be added to the payment subsystem by different applications 200 for use solely by that respective application.

The payment libraries 110 are used by wallet 100 to manage (and perform housekeeping tasks on) the secure element 120, interface with the system management back end 300, and perform over-the-air (OTA) provisioning via data communication transceiver (including its SMS channel), on the device 50. It is contemplated that the OTA data communications will preferably be encrypted in some manner and an encryption key may be deployed in card service module 420 (see FIG. 6). It is contemplated that wallet 100 and its functionality may be incorporated in the card services module 420 or may merely be in communication with the card services module 420.

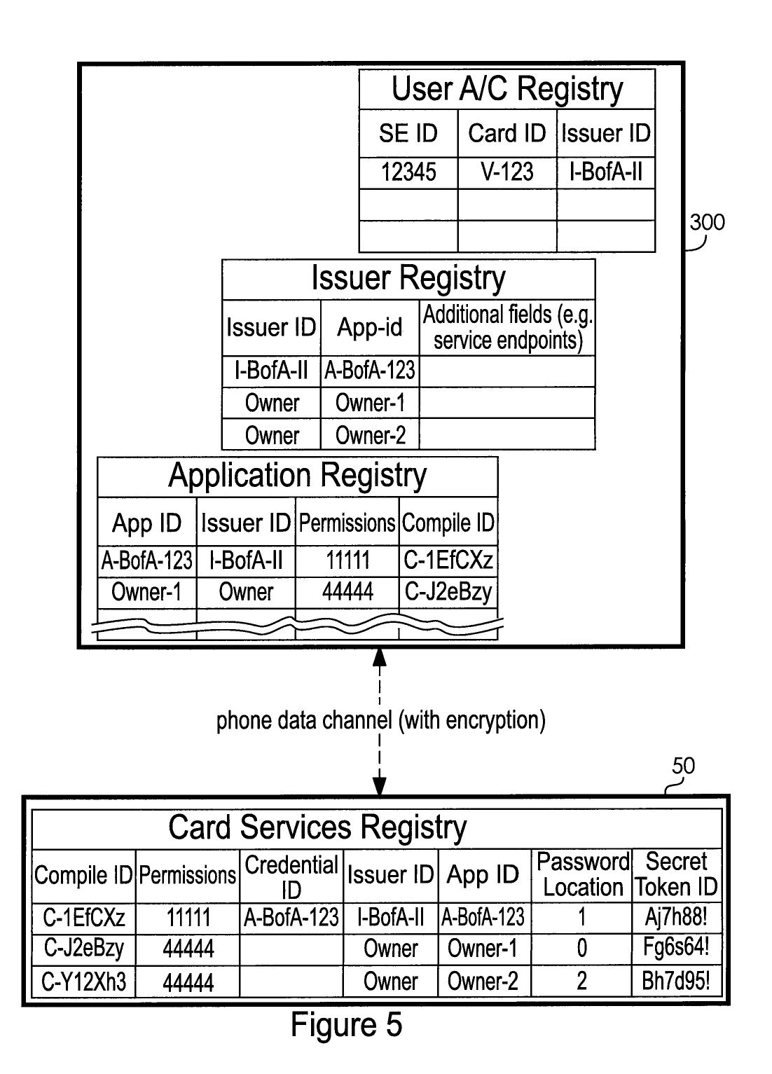

Wallet 100 (and more particularly the card services module 420) manages the complexity involved in the storage, maintenance and use of credentials such as card, coupon, ticket, access control data from one or multiple sources or issuers in association with the secure transactional subsystem 150. The card services module 420 also preferably enforces access control to the data stored in the secure transactional subsystem 150 and controls the function(s) each application is allowed to conduct with the secure transactional subsystem 150. In one approach, card services module 420 verifies the author/issuer of each third-party application 200 in use on the portable communication device 50. This verification may be accomplished by accessing a local authorization database of permitted (i.e., trusted) applications (see FIG. 5). Under this approach, only third party applications 200 that are signed with a known Issuer ID and the correctly associated Compile ID are allowed by card services module 420 to access and/or manipulate data stored in the payment transactional subsystem 150 or the meta data repository 125 (which stores, among other things, card image data and any embossed card data).

### Validating Third-Party Applications

The card services module 420 verifies the trusted status of any third-party application 200 before that application is allowed access to the secure element 120 (or secure data store 115 and even preferably the meta data repository 125) on the portable communication device 50 to view, select and/or change secure data stored in the payment subsystem 150. In one approach noted above, this verification may be accomplished by accessing a local authorization database of permitted or trusted applications. In a preferred approach, the local authorization database in cooperates with a remote authorization database associated with one or more servers associated with system management back end 300.

FIG. 5 is a block diagram of one potential implementation of one potential combination local and remote authorization databases to enhance security of the card services module 420, secure element 120, and payment subsystem 150. As shown in FIG. 5, a User A/C Registry (or User Account Registry) may be associated with the server (or otherwise deployed in the cloud). The User A/C Registry may store the identification of the secure element 120 disposed in each user's portable device 50. Entries in the User Account Registry may be added for each user at any point in the process.

The “Issuer Registry” database is a database of approved Issuers. The Issuer ID is unique for each type of credential. In other words, if a bank has multiple types of credentials (e.g. debit cards, credit cards, affinity cards, etc.) each credential type would have its own Issuer ID (e.g. I-BofA-II). In a preferred approach, the Issuer ID as between multiple types of credentials would have some common elements, so as to indicated that the credentials are at least related (e.g. I-BofA-I). In this way applications from same issuer can share data with the other application of the same “extended” issuer. In a preferred approach, card services module 420 can be simplified by requiring even the wallet user interface 410 (which “ships with the system”) to have an Issuer ID (and as well as an Application ID and Compile token).

The “Application Registry” is a database of applications (mostly third-party) that have pre-approved by an operating system provider. Like the User A/C Registry, the “Application Registry” and “Issuer Registry” database are maintained on the server side (or otherwise in the cloud) in operable association with the wallet 100. As would be understood by those of ordinary skill in the art having the present specification before them, the various registries may be implemented in separate databases or one unified database. At initiation of a wallet 100 and preferably at substantially regular time-intervals thereafter (e.g., daily), the data stored in the Application Registry of wallet is distributed to devices with the wallet to be stored locally.

As shown in FIG. 6, the Application Registry may include, among other information, an Application ID (“App ID”), an Issuer ID, and a Compile ID or token. The Compile ID is a global constant generated for each application by one or more processes associated with the wallet during the qualification process for the particular application 200. After it is generated by a particular card services module 420 on a unique device 50, the Compile token is included or otherwise associated with the application. This Compile token is preferably generated by a pseudo-random number generator local to the device (preferably in the secure element 120) that uses a pre-determined seed, such as the Application ID, Compile ID, Issuer ID or some combination thereof.

When the user seeks to qualify a third-party application with the card services module 420 on a device 50, the Compile ID (a digital token) and Application ID (a digital identifier) associated with the third-party application may be matched against the Compile ID and Application ID pairs stored in the Card Services Registry stored on the device 50 (see FIG. 6). As should be understood by those skilled in the art having the present specification before them, the same Compile and Application ID pairs are transmitted to other devices 50 associated with the system, as well. If the Compile ID/Application ID pair matches one of the pair-stored in the Card Services Registry on the device, a Secret Token ID is preferably generated on the device 50 by a pseudo-random number generator (such as the one associated with the Secure Element 120) and then stored in association with the Compile ID/Application ID pair in the Card Services Registry on the device 50. In some instances, the Compile ID may be pre-selected and used to seed the random number generator. It should be understood that one or more pieces of other predetermined data associated with the card services registry could be preselected as the seed instead. The card services Registry is preferably stored in secure memory (rather than the secure element 120 because secure element 120 has limited real estate) and the Card Services Registry is preferably further encrypted using standard encryption techniques. The Secret Token ID is also embedded in or otherwise associated with the application 200 on the device 50 in place of the Compile ID that was distributed with the application.

After the application has been loaded into the Card Services Registry (and the secret token embedded in the application), the third-party may launch and may prompt the user to opt-in to provide access to the issuer-specific credential needed for the validated (or trusted) application. In each subsequent launch of the third-party trusted application, the embedded Secret Token and/or Application ID are compared to the data in the Card Services Registry on the device. If there is match, the application is trusted and can access the payment subsystem 150 via card service module 420. In this manner, it can be seen that applications 200 or wallet user interface 410 may also be removed from the Card Services Registry and thus would be disabled from accessing the payment subsystem and possibly the application, altogether.

Card services module 420 also preferably uses the trusted application verification step to determine the appropriate level of subsystem access allowed for each application 200. For example, in one embodiment, one application 200a may be authorized to access and display all of the data contained in the payment subsystem 150, where another third-party application 200x may be only authorized to access and display a subset of the data contained in the payment subsystem 150. In yet another embodiment, an application may be permitted only to send a payment or transaction requests to wallet 100, but may not itself be permitted to access any of the data contained in the payment subsystem 150. In one approach, assignment of permissions to the application can be thought of as follows:

| | | All | Extended Issuer | Own |
|---|---|---|---|---|
| | Reserved | Credentials | Credentials | Credentials |
| Read | 0 | 0 or 1 | 0 or 1 | 0 or 1 |
| Write | 0 | 0 or 1 | 0 or 1 | 0 or 1 |
| Delete | 0 | 0 or 1 | 0 or 1 | 0 or 1 |
| Activate/ | 0 | 0 or 1 | 0 or 1 | 0 or 1 |
| Deactivate | | | | |
| Download | 0 | 0 or 1 | 0 or 1 | 0 or 1 |
| Credential | | | | |

These permission can be used to form 4 hexadecimal number in the order shown above from most to least significant figure. As shown in the example Card Services Registry of FIG. 5, the I-BofA-II issuer has permission level 11111, which can be thought to expand to 0001 0001 0001 0001 0001. In other words, the I-BofA-II application can read, write, delete, activate/deactivate, and download its own credentials but not the extended issuer credentials let alone all credentials. If BofA had another issuer code (e.g. I-BofA-I), then that would be an extended Issuer application. So, if the permission level of the application associated with Issuer ID “I-BofA-II” was set to 0010 0001 0001 0010 0001 (or 21121 hexadecimal) then the application would be able to read and activate/deactivate the credentials associated with both issuer IDs. In yet another example, the wallet user interface 410 may be given a permission level of 44444 (i.e. 0100 0100 0100 0100 0100). In other words, the wallet user interface 410 can read, write, delete, activate/deactivate, and download all credentials. As would be understood by those of ordinary skill in the art, these are merely examples of potential permissions that can be granted to applications, other permissions are contemplated. For instance, some applications may have the ability to read extended issuer credentials, but only write, delete, activate and download the application's own credentials (e.g. 21111, which expands to 0010 0001 0001 0001 0001). In yet another example, an application may only be given activate/deactivate and download rights (e.g. 0000 0000 0000 0001 0001 or 00011 in hexadecimal). In yet another example, an application may be disabled—without being deleted from the trusted application database or Card Service Registry—by setting all rights to zero.

When an application 200 needs to interact with the secure transactional subsystem 150, it does so by passing a digital identifier (such as its Issuer ID or App ID), a digital token (i.e., Compile ID or Secret Token ID), the desired action, and any associated arguments needed for the action to the card services module 420. Card services module 420 verifies the digital identifier-digital token pair matches trusted application data in the secure data table (FIG. 5), and then issues the one or more commands necessary to execute the desired action. Among the potential actions that may be used by applications 200 are those associated with:
a. wallet management (e.g., setting, resetting or enabling wallet passcodes; get URL of OTA server; over-the-air registry provisioning; setting payment timing; increasing payment timing; set default card; list issuers; list supported credentials; set display sequence of credentials; set credential storage priority; create categories/folders; associate credentials with categories; memory audit; determine SE for storage of credential; get Offers; update wallet status)
b. credential management (e.g., add credential; view credential detail; delete credential; activate credential (for redemption/payment); deactivate credential; search credentials; list credential capability; set default credential; lock/unlock credential; require passcode access; get credential image; set access passcode)
c. Secure Element (SE) Management (e.g., get credential; update credential; update meta data; delete credential; wallet lock/unlock; SE lock/unlock)
d. Personalization (e.g., add credential; delete credential; suspend/unsuspend credential; notification for issuer metadata update; notification for card metadata update)
e. Password management (e.g., add password, delete password, verify password).

### Password Manager Application

The password management system 350 (in conjunction with the card services module 420) stores and maintains one or more passwords in the secure transactional subsystem 150 (i.e. secure element 120 or secure data store 115) and further validates access attempts to applications based on a comparison of the securely stored password with a presently entered string. In particular, the password management system 350 provides only a “yes/no” response, which determines, in turn, whether access to the respective third party application 200 is provided to the user. Any number of third party applications 200 may be supported by the password management application subject primarily to the space limitations of the secure transactional subsystem 150. Because the password management application is relatively simple, it should be understood by those of ordinary skill in the art that the pertinent functionality of the password management and the card services module 420 may be incorporated completely into the password management system 350 to provide a thinner approach to the present invention.

The password management system 350 provides an interface through which a user may register, provision, access and/or use the information securely stored in the secure transactional subsystem 150 in association with the card services module 420 relating to the user's credentials. FIG. 2 illustrates one exemplary user interface that may be deployed on a smart phone to support user check-in to an application, such as third party application 200c. This user interface will most likely be generated by the third party application, itself. The information (i.e. user name, password, create new user) input into this user interface will be directed to the password management system 350 where the information will be stored in the secure transactional subsystem 150 a manner in which it can be used for future “yes/no” verification of the user-password combination. In some instances, the user name may be practically omitted because the user name is static. For instance, where the application 200c or the portable communication device 50 has only a single user, the user name may be fixed or otherwise preset. However, the specification will continue to speak in terms of user-password combinations or pairs with the understanding that the meaning of this term would include the various alternatives contemplated.

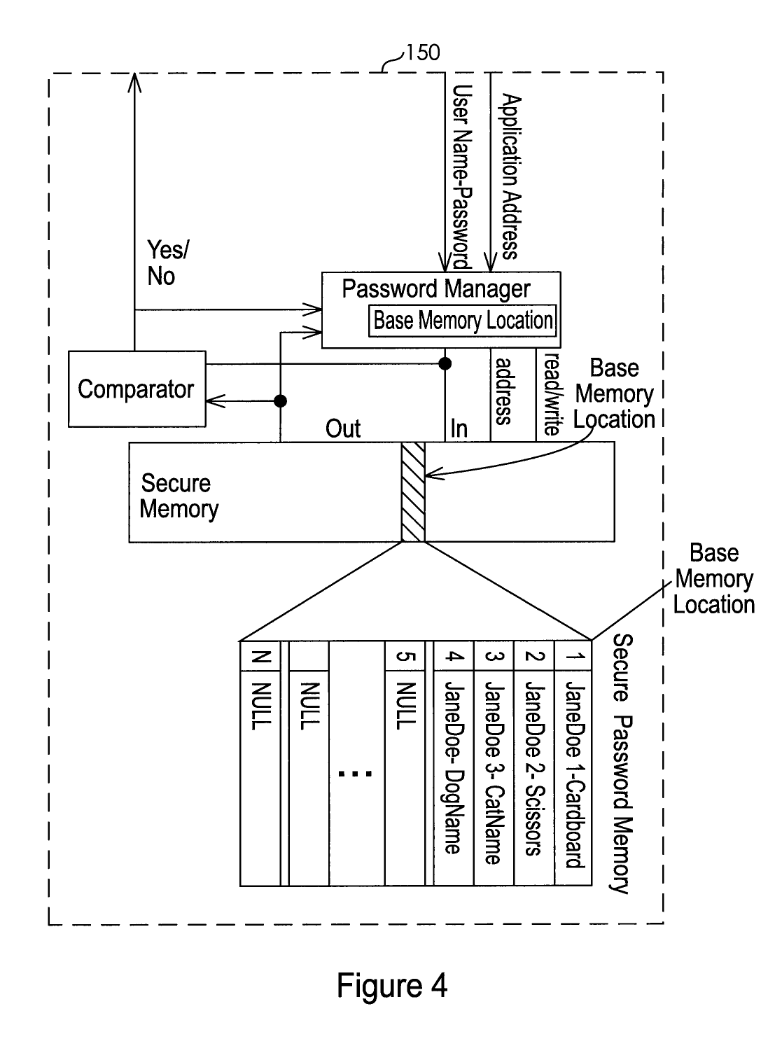

FIG. 4 illustrates details of one exemplary implementation of the password management system 350 and its operation in connection with other aspects of the disclosure. In particular, FIG. 4 illustrates secure transaction subsystem 150, which includes password management system 350 implemented as password manager application and comparator module and further includes secure element 120 and/or secure data store 115 implemented as secure memory.

The registration and storage of user name and password information for each application (e.g., application 200c) in communication with secure transactional subsystem 150 is provided to the password manager application which manages the storage of such information in the secure memory. Password manager application may include or otherwise communicate with a base memory location module that provides the password manager application with a base memory address location corresponding to the application address for secure storage of the user name and password pair information. Password manager application writes the user name and password information to secure memory and, in particular, to the base memory location associated with the application address. With reference to FIG. 4, base memory location 1 may correspond to a first application address (and thus a first application). Stored within the secure memory at base memory location 1 is the user name and password pair associated with the first application (e.g., “JaneDoe 1 and Cardboard”). Similarly, base memory location 2 may correspond to a second application address (and thus a second application) and stored within the secure memory at base memory location 2 is the user name and password pair associated with the second application (e.g., “JaneDoe 2 and scissors”).

To ensure that the correct user name and password are stored in secure memory, password manager provides the user name and password, as entered by the user, to the comparator module and issues a read request to the base memory location address where the user name and password were stored. In response to the read request, the stored user name and password are provided to the comparator module where the stored user name and password are compared to the originally-provided user name and password. The comparator module then performs a compare operation comparing the provided user name and password to the stored user name and password.

If the comparison module determines that credentials match, then comparator module issues a “yes” response to the password manager application and/or to the card services module and access control as is described herein and illustrated in FIG. 3. A “yes” response indicates that the user's user name and password have been correctly stored. If the comparison module determines that the credentials do not match (i.e., where one or more of the provided user name and the provided password does not match what is stored in secure memory), then the comparator modules issues a “no” response to the password manager application and/or to the card services module and access control as is described herein and illustrated in FIG. 3. A “no” response indicates that the user's name and password to the secure memory were not correctly stored. If a “no” response is issued, either the password manager application attempts to rewrite the correct user name and password or the third party application 200c attempts to re-provide the desired user name and password for storage in secure memory.

Subsequent to the storage of a user name and password pair within secure memory, when a user attempts to access an application such as application 200c that requires a user to check in with credentials, the user's user name and password (as entered by the user) and the application address associated with the application are provided to the password manager application. Password manager application provides the provided user name and password to the comparator module. Password manager identifies the base memory location associated with the provided application address using the base memory location module and issues a read request to secure memory to read the user name and password stored in secure memory at the base memory location associated with the provided application address. In response to the read request, the stored user name and password stored at the base memory location are provided to the comparator module.

Comparator module then performs a compare operation comparing the provided user name and password to the stored user name and password. If the comparison determines that the user has provided the correct credentials, then the comparator module issues a “yes” response to the card services module 420 and to access control as is described herein and illustrated in FIG. 3. A “yes” response indicates that the user has provided the correct credentials and should be provided access to the application (e.g., application 200c). If, however, the comparator module determines that the user has provided incorrect credentials (i.e., where one or more of the provided user name and the provided password does not match what is stored in secure memory), then the comparator module issues a “no” response to the card services module 420 and to access control. A “no” response indicates that the user has provided the incorrect credentials and should not be provided with access to the application (e.g., application 200c).

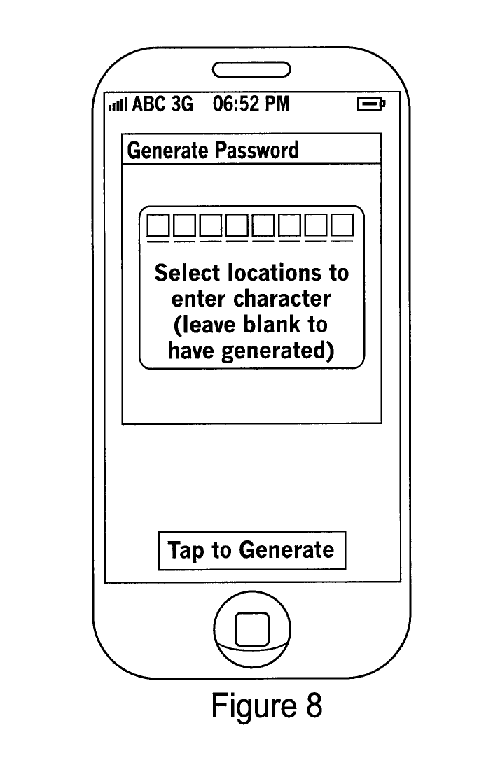

In one potential embodiment shown in FIG. 8, the password management system 350 may further include functionality to generate a strong password, either in whole or in part, (for example, if a user is having trouble manually coming up with a strong password). By selecting “Generate Password,” the end user may be given an option to manually enter certain characters and leave the rest of the password to random generation. As an example, if the password generating feature is configured to generate an 8-character password, the user may decide to enter a portion of the password manually to make the password easier to remember. For example, the user may want the first 4 digits to be the first 4 letters of her favorite food (e.g., CHOC____). Then, for each character that she wants to have generated by the application, she may either leave it blank, or identify each as either a letter or a number (e.g., CHOC[#][#][L][L]). Then, “Tap to Generate” is selected, after which letters and numbers would be pseudo-randomly generated (as indicated by the user or in an unconstrained manner if the user does not constrain the types), and then the resulting password is shown to the user. The user may then be given the option to copy the generated password into one of the entries in the password manager. As would be understood by one of skill in the art, there may be additional user-selectable options for the password manager creation of password element (such as “Capital Letters Only” or “Numbers Only”), which the user may apply as desired.

In one embodiment, once the user selects “Tap to Generate,” a request to generate a random (or pseudo-random) password is sent to a random/pseudo-random PIN generator. Preferably, such random/pseudo-random PIN generator is local to the device (preferably to the secure element 120), and is the same generator used to generate the Compile token, as discussed further below. Once generated, the PIN is then sent back to the password manager application for use in generating the password as requested by the user.

In an embodiment where the password manager application is configured as one of the third-party applications it would have to be registered in order to access the wallet 100 (or more particularly card services module 420). Because the password manager application is not an issuer, does not manipulate true NFC credentials and should not be allowed access to other credentials it should be given permission level 11100, which can be thought to expand to 0001 0001 0001 0000 0000. In other words, the password manager application would be allowed to read, write, and delete its own “credentials” but not activate/deactivate or download credentials.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for controlling access to an application on a portable communication device having a secured element and a user interface, the system comprising:
memory associated with the secure element;
a card management module operably associated with the portable communication device and with the secure element capable of controlling the secured element to facilitate writing to and reading from the memory;
a password management module operably associated with the card management module, the portable communication device user interface, and the application, the password management module receiving an application identifier associated with the application, a user name, and a password from the user interface, and providing an access command to the application based on whether the received user name and password match information stored in the memory.

2. The system according to claim 1 wherein the memory associated with the secure element is within the secure element.

3. The system according to claim 1 wherein the memory associated with the secure element is outside the secure element and an encryption key is used to encrypt contents of the memory.

4. The system according to claim 3 wherein the encryption key is stored within the secured element.

5. The system according to claim 2 wherein the memory is located within the portable communication device.

6. The system according to claim 1 wherein the secure element includes a pseudo-random number generator, the graphical user interface further comprising an interface for creating passwords with portions generated by the pseudo-random number generator.

7. The system according to claim 1 wherein the operable connection between the card management module and the graphical user interface is a trusted connection.
